(19) United States
(12) Patent Application Publication
(10) Pub. No.: US 2004/0029073 A1
(43) Pub. Date: Feb. 12, 2004

(54) Rubber dam

(75) Inventors: Beat Kilcher, Bosco Luganese (CH); Marco Da Rold, Vaglio (CH); Felix Aschmann, Basel (CH)

Correspondence Address: Donald F. Frei, Wood, Herron & Evans, L.L.P., 2700 Carew Tower, 441 Vine Street, Cincinnati, OH, 45202-2917, US

(73) Assignee: KerrHawe SA

(21) Appl. No.: 10/393,119

(22) Filed: Mar. 20, 2003

(30) Foreign Application Priority Data
Mar. 25, 2002 (CH) 2002 0510/02

(51) Int. Cl. A61C 5/14

(52) U.S. Cl. 433/136

(57) ABSTRACT

A preferred rubber dam comprises a bag provided, at the locations situated above teeth when the rubber dam is applied in the mouth, with projections that are intended to be cut off. The projections with the resulting holes are closely fitted on the teeth to be treated in order to seal off the oral cavity.

### BACKGROUND OF THE INVENTION

The invention refers to a rubber dam comprising a covering foil. A rubber dam is an auxiliary device used in dental treatments for separating the teeth under treatment from the remainder of the oral cavity. This allows the working area to be kept dry and relatively sterile while the patient is protected from swallowing or aspirating cooling water, drilling residues or, as the case may be, from the impact of instruments. To this end, for over 100 years, a hole has been cut in a rubber sheet and the latter has been drawn over the tooth that is to be treated in such a manner that the border of the hole in the rubber sheet rests on the hard tooth and the rubber sheet covers the gums while the upper portion of the teeth can be treated.

The difficulty in the application of this technique is in choosing the appropriate distance between the holes, even if templates are used, as this distance varies from patient to patient according to the size of the dentition, on account of misaligned teeth, and according to the thickness of the used rubber dam.

In particular, the chosen distance may be too small, so that the rubber portion left between the teeth is too short to contact the teeth and to cover the gums in the dental interstice (papilla). As a result, the interdental portion of the rubber will glide to one side of the papilla, and the sealing action is no longer ensured.

Furthermore, while cutting a hole for the tooth or several holes, there is a risk that these holes are improperly cut and ragged, thereby creating a considerable risk of being torn open.

### SUMMARY OF THE INVENTION

On the background of this prior art, it is the object of the present invention to improve the rubber dam in such a manner as to eliminate the risk of its slipping out of place and to substantially reduce the risk of being torn apart, and to ensure an optimum sealing action even in the case of more pronounced misalignments of teeth. This is accomplished by the rubber dam wherein the locations of the foil situated above teeth when applied in the mouth are provided with projections or depressions that are intended to be cut off.

Another object is to offer the patient the highest possible comfort. This is accomplished by the rubber dam wherein the projections are arranged anatomically according to the disposition of the teeth. Different embodiments and improvements are defined in the dependent claims.

### BRIEF DESCRIPTION OF THE DRAWINGS

The invention is explained hereinafter with reference to drawings of exemplary embodiments.

FIG. 1 shows two exposed teeth with the papilla covered by a rubber dam,

FIG. 2 schematically shows a rubber dam according to the invention provided with projections for the entire jaw,

FIG. 3 schematically shows a rubber dam according to the invention provided with projections for the right quadrant,

FIG. 4 schematically shows a rubber dam according to the invention provided with projections for the right sextant of the jaw,

FIG. 5 shows cut projections in another rubber dam according to the invention,

FIG. 6 shows a variant of FIG. 5 provided with depressions instead of projections,

FIG. 7 schematically shows an exemplary embodiment of a rubber dam according to the invention in a side view,

FIG. 8 shows the rubber dam of FIG. 7 from above,

FIG. 9 shows the rubber dam of FIG. 7 in a sectional view,

FIG. 10 shows the rubber dam of FIG. 7 in a perspective view,

FIGS. 11A-11C show a first exemplary embodiment of a rubber dam frame in three views,

FIGS. 12A-12C show a second exemplary embodiment of a rubber dam frame in three views, and

FIG. 13 shows a rubber dam according to FIG. 7 stretched over a frame according to FIG. 11 in a view from below.

### DETAILED DESCRIPTION OF THE INVENTION

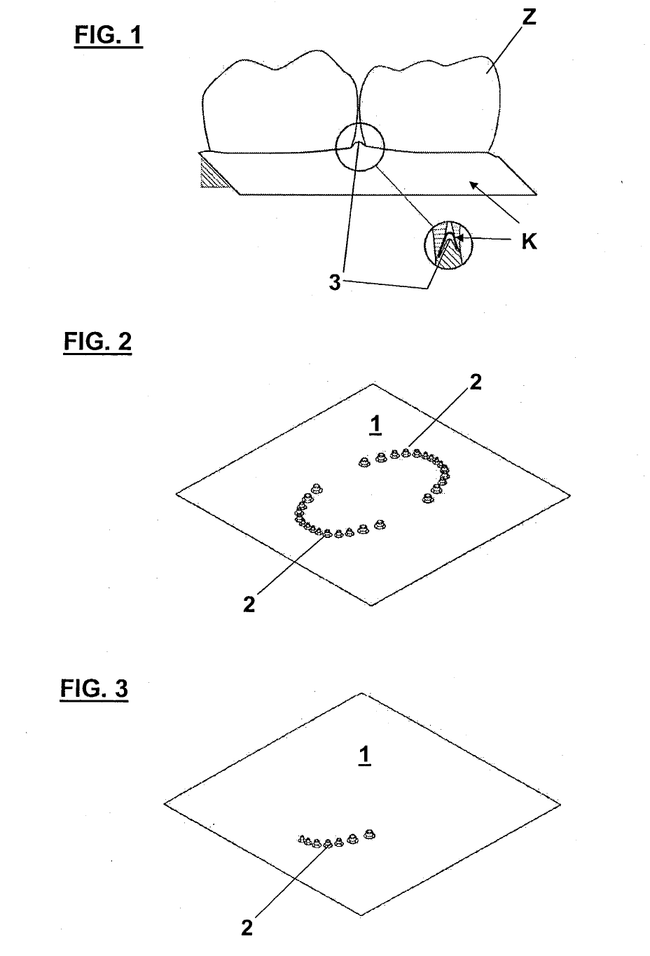

FIG. 1 illustrates the application of a rubber dam K, placed around and between two teeth Z and covering papilla 3. In a usual manner, the rubber dam is fastened in the oral cavity by means of clamps.

FIG. 2 shows an exemplifying configuration of projections for both jaws, rubber dam 1 being only schematically illustrated as a rectangular sheet, e.g. a rubber sheet, while projections 2 are provided for the teeth of the entire jaw.

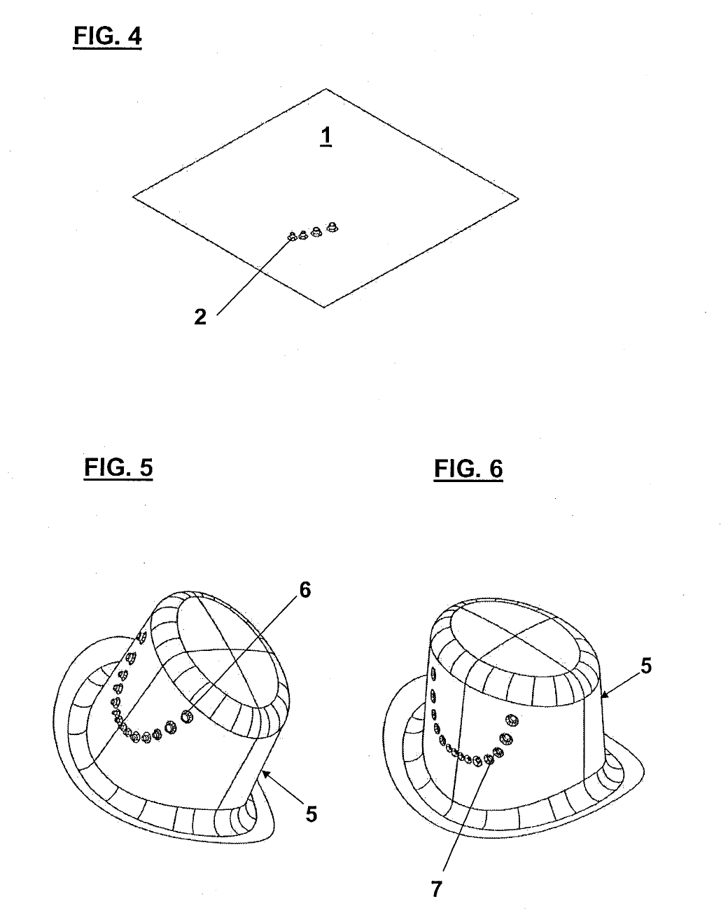

According to FIGS. 3 and 4, projections are provided only for the right quadrant or for the left sextant of the jaw. The projections may also be provided for the left quadrant or sextant or for the central sextant, or else for individual teeth.

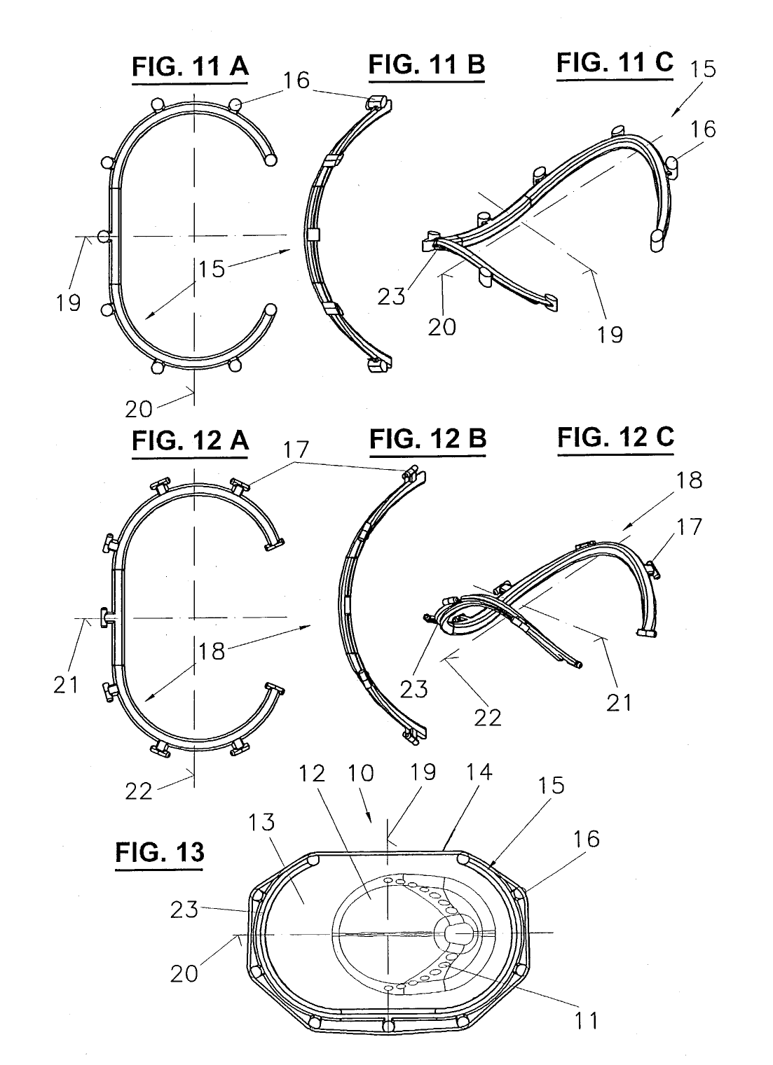

The inventive projections in a rubber dam may be provided on all kinds of rubber dams, i.e. on a flat rubber dam similar to a sheet according to FIGS. 1 to 4 and, according to FIGS. 5 to 10, on a rubber dam having a depression, e.g. according to U.S. Pat. No. 174,942, and comprising besides the covering means a fastening device allowing to attach the depression or bag both in the oral cavity and on the outside, see e.g. WO 98/34559, or on a rubber dam used with frames according to FIGS. 11 and 12.

In the three-dimensional rubber dam bags, the projections may also extend inwards, i.e. take the form of depressions. Also, the projections may be provided in different configurations, e.g. for both jaws, for one jaw, for entire quadrants or sextants or only for individual teeth.

In FIG. 5, a configuration for the entire jaw is illustrated, the rubber dam comprising a three-dimensional bag as described above and as disclosed and discussed in detail in the cited references. As further appears in FIG. 5, projections 6 on the rubber dam bag 5 are partially cut away for slipping them on the teeth.

For this purpose, the diameter of holes 6 will be adapted to the teeth, the diameter generally being chosen such as to correspond to about a quarter of the diameter of the teeth to be covered in order to ensure a maximum adhesion of the projections and of the rubber dam on the tooth, so that the papilla and the oral cavity are maximally covered and a good isolation is obtained. Thus, the rubber dam will rest flat on the circumference of the tooth, and the portion adjacent the tooth is placed in the sulcus (gingival pocket) for a maximum exposure of the tooth and a better retention of the rubber dam.

In analogy, the same applies to depressions 7 according to FIG. 6.

On the basis of the illustrated and described examples, the conventional hole technique may additionally be applied if the projections are not appropriately located in special situations, so that the rubber dam of the invention may be used in this case as well.

Besides the described examples of rubber dams, i.e. the simple rectangular sheet and the bag-like rubber dam with attaching means, there is a large number of different embodiments of rubber dams that may be provided with the projections or depressions of the invention in a large number of variations.

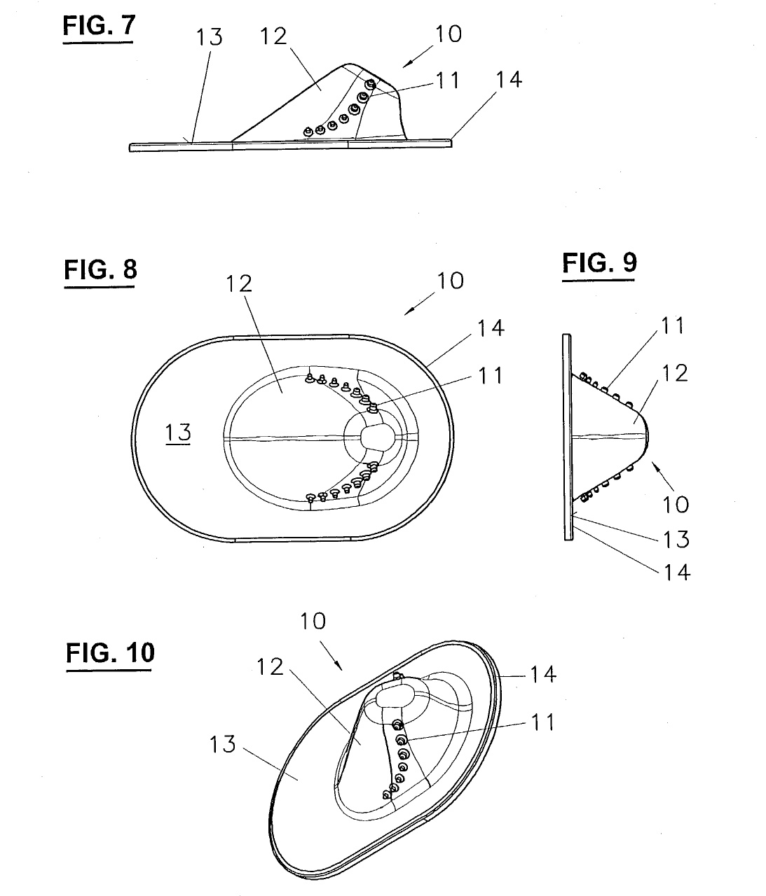

FIGS. 7 to 10 schematically show a tested embodiment of a rubber dam offering a secure retention and a good sealing action, on one hand, and a comfortable application for the patient, on the other hand.

As an improvement over the preceding examples, the projections 11 on rubber dam 10 are arranged anatomically, i.e. according to the disposition of the teeth. The same applies to bag 12 of the rubber dam, which is not arranged and shaped symmetrically with respect to the essentially plane rim 13, but eccentrically and obliquely. The illustrated orientation and size as well as the shape of the bag results in a largely tension-free adaptation of the bag in the pharynx, so that the dentist may work under optimum conditions and the patient is not disturbed by the bag. Furthermore, this shape and arrangement allows to use relatively soft clamps.

A third element contributing to the improvement of the rubber dam is circular bulge 14. On one hand, the latter serves for receiving a rubber dam frame, and on the other hand, as a delimitation in the area where the frame is ineffective, thereby avoiding the need of cutting off the projecting portion of the rubber dam that is uncomfortable for the patient.

In FIGS. 11 and 12, two variants of a rubber dam frame are illustrated. C-shaped frame 15 of FIG. 11 is vaulted in two planes. The first convexities with respect to center line 19 appear in FIG. 11A, and the second convexities with respect to second center line 20 appear in FIG. 11C, the frame thus being formed of two halves each of which is vaulted in two planes. The result is a better adaptation of the rubber dam frame to the facial anatomy without producing excessive tensions on the lips. Thus, an easy introduction of the saliva ejector is possible, and a sufficient opening remains for the patient to breathe comfortably.

On its outer edge, frame 15 is provided at intervals with retaining elements 16 serving for the retention of the slipped-on rubber dam, see FIG. 13. The retaining elements may have a button-like shape 16 as in FIG. 11, or retaining elements 17 on rubber dam frame 18 may be T-shaped, while other shapes are quite possible. The retaining elements are so designed that the rubber dam remains in the fixed position with little tension and is not displaced any more.

Rubber dam frame 18 with retaining elements 17 according to FIG. 12 is also vaulted with respect to center lines 21, 22 in two planes. Instead of being C-shaped, the frames may also be U-shaped. Also, the frames may be plane, or vaulted in one plane only.

In FIG. 13, the rubber dam of FIG. 7 is stretched on the frame of FIG. 11. In this view from below, i.e. looking into the bag and in the direction of the pharynx, the projections are illustrated schematically only. It also appears that the rim of the frame is provided with an external circular groove 23 in which the bulge 14 of the rubber dam is partly inserted, thereby providing a stable position. A rubber dam mounted in this manner may be fastened in the mouth of the patient by clamps or the like without causing discomfort even in long sessions while a good sealing action is maintained for a long time.

We claim:

1. Rubber dam, comprising a covering foil, wherein the locations of the foil situated above teeth when applied in the mouth are provided with projections or depressions that are intended to be cut off.

2. Rubber dam according to claim 1, wherein the projections or depressions are provided for a determined number of teeth.

3. Rubber dam according to claim 2, wherein projections for the teeth of the entire jaw are provided.

4. Rubber dam according to claim 1, wherein the hole diameter of a cut projection or depression is approximately equal to ¼ of the diameter of the exposed tooth.

5. Rubber dam according to claim 1, wherein it is designed in the manner of a bag and comprises a circular rim around the bag, the bag being disposed asymmetrically with respect to the plane of the rim and non-perpendicularly thereto.

6. Rubber dam according to claim 1, wherein the projections are arranged anatomically according to the disposition of the teeth.

7. Rubber dam according to claim 5, wherein the rubber dam comprises a circular bulge.

8. Rubber dam frame for the attachment of a rubber dam according to claim 5, wherein it has a C- or U-shaped configuration and is vaulted in two planes with respect to two center lines.

9. Rubber dam frame according to claim 8, wherein its outer edge is provided with retaining elements.

10. Rubber dam frame according to claim 9, wherein the retaining elements are sharp-edged.

11. Rubber dam frame according to claim 8, wherein the outside of its edge is provided with a circular groove.
